(19) United States
(12) Patent Application Publication
(10) Pub. No.: US 2011/0019898 A1
(43) Pub. Date: Jan. 27, 2011

(54) CELL-IMAGE ANALYZING APPARATUS

(75) Inventors: Kosuke TAKAGI, Kawagoe-shi (JP); Genta AMAKAWA, Tokyo-to (JP); Akira SAITO, Tokyo-to (JP); Yuichiro MATSUO, Tokyo-to (JP)

Correspondence Address: HOLTZ, HOLTZ, GOODMAN & CHICK PC, 220 Fifth Avenue, 16TH Floor, NEW YORK, NY, 10001-7708, US

(73) Assignee: Olympus Corporation, Tokyo (JP)

(21) Appl. No.: 12/842,550

(22) Filed: Jul. 23, 2010

(30) Foreign Application Priority Data
Jul. 24, 2009 (JP) 2009-173472

(51) Int. Cl. G06T 7/00

(52) U.S. Cl. 382/133

(57) ABSTRACT

A cell-image analyzing apparatus is provided with a computer, for classifying cells using plural channels of fluorescence cell images on a specimen that contains plural kinds of cells and is stained with specific fluorochromes in accordance with the kinds of cells. The cell image analyzing apparatus has an image analysis software that makes the computer function as a region delimiting mean for delimiting cell nucleus regions and cytoplasm regions in each of the plural channels of fluorescence cell images; a morphologic characteristic detecting means for detecting a morphologic characteristic on the cell nucleus regions or the cytoplasm regions delimited via the region delimiting means; and a cell classifying means for classifying the cells into kinds in accordance with the morphologic characteristic on the cell nucleus regions or the cytoplasm regions detected via the morphologic characteristic detecting means.

This application claims benefits of Japanese Patent Application No. 2009-173472 filed in Japan on Jul. 24, 2009, the contents of which are hereby incorporated by reference.

### BACKGROUND OF THE INVENTION

1) Field of the Invention

The present invention relates to a cell-image analyzing apparatus that automatically analyzes cell images acquired upon photographing of a specimen containing plural kinds of cells, to classify the cells into specific cell kinds. To be specific, the present invention relates to a cell-image analyzing apparatus that classifies cells into plural cell kinds such as neuron/astrocyte , by analyzing colors of fluorescence cell images acquired upon photographing of neuron/astrocyte of neural cells stained with different fluorochromes, respectively,

2) Description of the Related Art

When neural stern cells, for example, are cultured under an appropriate condition, they are differentiated into plural cell kinds such as neuron/astrocyte. In this situation, it is possible to induce differentiation by adding an appropriate chemical, compound. For example, it is known that the proportion of differentiation into neurons is increased by adding, in culturing, an agent that induces different into neurons.

For screenings for differentiation-inducing chemical compoun. or agents, there will be conducted a procedure in which a specimen containing plural cells is cultured in or transferred into a specific container such as a microplate, stained with fluorochromes, photographed via a microscopic photographing apparatus or the like, and the acquired images are analyzed using a cell-image analyzing apparatus,

The staining of the cells is made using specific staining agents in accordance with cell kinds. In other words, the cells are stained with different staining agents in accordance with kinds of the cells. The cell nuclei also are stained with an appropriate compound such as DAPI (4′, 6-diamino-2-phenylindole) A photographing shot for a cell image is taken for each cell staining (for each channel) For example, as shown in FIG. 1, in the case where plural kinds of cells coexist, the specimen is stained with staining agents specific to the respective kinds of cells (cytoplasm) and photographed. The analysis is made on the captured images, to detect the number, the proportion etc. of the presence of cells stained in each channel.

In the photographing, microscopic fluorescence images are taken for plural target points in the container. For example, by moving a motorized stage that mounts the container, cell images are taken at plural points. As positions of the container (motorized stage) when the cell images are taken, corresponding positions XY coordinate system perpendicular to the optical axis of the photographing optical system of the microscope are recorded.

The captured cell images are analyzed using the cell-image analyzing apparatus, the number of cells in each container or each captured image are totaled for each kind of cells, and further, the sum or the proportion of a specific group is calculated using the totaled values.

As a cell-image analyzing apparatus of this type, there is conventional one, for example, referred to in the operation manual “Analysis Software Operation, CELAVIEW RS100”, ver. 1.4, pp. 3-17, published by Olympus Corporation.

Regarding analysis of cell images, the following cases are envisioned:

(1) where only a specific kind of cells are stained with a fluorochrome of one color, and the other kinds of cells are contained in the specimen as remaining unstained. In this case, the number of stained cells is detected from a cell image.

(2) where plural kinds of cells are specifically stained with plural fluorochromes, respectively, and the cell density is low. In this case, staining is made with one color per channel, the color differing by channel, and cell images are analyzed for the respective channels.

(3) where plural kinds of cells are present and the cell density is high. In this case, especially for cells clustered close together, it is necessary to apply a predetermined relative criterion for determination of the kinds of the cells.

Conducting cell classification automatically by using a cell image analyzing apparatus has a great significance in that it facilitates the reduction of processing time and the achievement of a large amount of analysis. The automation of the work is indispensable especially for screenings of chemical compounds.

However, according to the conventional cell-image analyzing apparatuses, in the case where a specific kind of cells are stained with one color, the determination of whether or not a cell in concern is stained would he questionable, as explained as follows. Since the form of cytoplasm has a certain expanse, the marginal portion of a cell may overlap another cell. In the case of neural cells, in particular, a “foot” of a cell often extends to overlap another cell.

For example, in the case where a cell 1 and a cell. 2 shown in FIG. 2A are different kinds of cells and a cell image is captured upon the cell 1 alone being stained with a fluorochrome of a channel 1, if, in the fluorescence cell-image analysis, determination is made of the kinds of cells by using only the channel 1 fluorescence on the cell nucleus regions 1 and 2, the cell 2 is liable to he misjudged as also belonging to the same kind of cells as the cell 1, which is associated with the channel 1, as shown in FIG. 2B.

Regarding the method of determining kinds of cells using a relative criterion, normally used is a technique in which determination is made using the amount of each channel's fluorescence (total amount of fluorescence or average luminance) on cell nuclei and masks around the cell nuclei. This technique cannot be applied in the case where the cytoplasm overlaps another cell. This technique is explained in reference to FIG. 3.

According to this technique, first, a nucleus region of a cell is detected as shown in FIG. 3A, Then, as shown in FIG. 3B, cytoplasm is defined by a region widened from the nucleus region created in such a way that the boundary line of the nucleus region is simply expanded by a predetermined thickness of the order of several pixels. Then, the kind of the cell is determined on the basis of the luminance data of the defined cytoplasm. In the example of FIGS. 3, the luminance of the cytoplasm of the cell 1 is higher than the luminance of the cytoplasm of the cell 2 and thus the cell 1 and the cell 2 are distinguishable in accordance with luminance.

According to this technique, however, in the case where the bright cell 1 and the dark cell 2 are close together to overlap one another as shown in FIG. 3C, since the cell nucleus of the cell 2 is in the range of the defined cytoplasm of the cell 1 and accordingly the region of the cell nucleus of the cell 2 is detected as having a brightness satisfying the luminance for the cell 1, the cell 2 is liable to he misjudged as a cell associated with the channel 1 (i.e., belonging to the same kind of sells as the cell 1) as shown in FIG, 3D, similar to the case of FIG. 2.

In addition, in the case where plural kinds of cells are clustered, it is inherently difficult to classify the cells on the basis of cell images.

If the cell density is low, it is relatively easy to conduct an automatic analysis for each kind of cells on the basis of cell images. However, regarding cells such as neural cells that would perish under the solitary condition, observation cannot be made under the condition of decreased cell density.

Therefore, the neural, cells or the like should be automatically analyzed under the condition of substantially high cell density. However, it is very difficult to distinguish the individual cell because of overlap with cytoplasm of other cells.

### SUMMARY OF THE INVENTION

A cell-image analyzing apparatus according to the present invention is provided with a computer, for classifying cells using plural channels of fluorescence cell images on a specimen that contains plural kinds of cells and is stained with specific fluorochromes in accordance with the kinds of cells. The cell-image analyzing apparatus has an image analysis software that makes the computer function as: a region delimiting means for delimiting cell nucleus regions and cytoplasm regions in each of the plural channels of fluorescence cell images; a morphologic characteristic detecting means for detecting a morphologic characteristic on the cell nucleus regions or the cytoplasm regions delimited via the region delimiting means; and a cell classifying means for classifying the cells into cell kinds in accordance with the morphologic characteristic on the cell nucleus regions or the cytoplasm regions detected via the morphologic characteristic detecting means.

In the cell-image analyzing apparatus of the present invention, it is preferred that the morphologic characteristic detecting means detects positions of center points of the cytoplasm regions delimited via the region delimiting means and detects positional relations between the center points of the cytoplasm regions and the cell nucleus regions, and that the cell classifying means automatically classifies the cells into specific cell kinds, respectively, in accordance with the positional relations between the center points of the cytoplasm regions and the cell nucleus regions detected via the morphologic characteristic detecting means.

In the cell-image analyzing apparatus of the present invention, it is preferred that the morphologic characteristic detecting means detects Central regions, which form somas, from the cytoplasm regions delimited via the region delimiting means and quantifies states regarding overlaps between the central regions forming the somas and the cell nucleus regions, and that the cell classifying means automatically classifies the cells into specific cell kinds, respectively, in accordance with the states regarding the overlaps between the central regions forming the somas and the cell nucleus regions.

In the cell-image analyzing apparatus of the present invention, it is preferred that the morphologic characteristic detecting means detects overlaps each between one of the cytoplasm regions and one of the cell nucleus regions delimited via the region delimiting means, and that the cell classifying means automatically classifies the cells into specific cell kinds, respectively, in accordance with a relation in size between the respective overlaps each between one, of the cytoplasm regions and one of the cell nucleus regions.

In the cell-image analyzing apparatus of the present invention, it is preferred that the region delimiting means delimits the cell nucleus regions in each of the plural channels of fluorescence cell images, analyzes fluorescence distribution in neighbouring regions around the cell nucleus regions to detect luminance of cytoplasm in the neighbouring regions, and determines the cytoplasm regions near central portions of somas in accordance with the luminance of the cytoplasm in the neighbouring regions around the cell nucleus regions.

According to the present invention, it is possible to provide a cell-image analyzing apparatus that is capable of conducting appropriate automatic classification of different kinds of cells coexisting under the high cell-density condition, such as neuron/astrocyte of neural cells.

These and other features and advantages of the present invention will become apparent from the following detailed description of the preferred embodiment when taken in conjunction of the accompanying drawings.

### BRIEF DESCRIPTION OF THE DRAWINGS

FIG. 1 is a diagram that shows the state where a specimen containing plural kinds of cells (cell 1, cell 2) is stained with staining agents specific to the cells (cytoplasm).

FIGS. 2A and 2B are explanatory diagrams for illustrating a problem involved in the situation where one kind of cells is stained in a specimen containing plural kinds of cells. To be specific, FIG. 2A shows the state where two cells different in kind are positioned so that the nucleus of one overlaps the cytoplasm region of the other and only one of the cells is stained; and FIG. 2B illustrates the state where determination of cell kind is made by using only the fluorescence on the nucleus regions of the two cells.

FIGS. 3A-3D are explanatory diagrams that show the method of determining cell kind using the amount of each channel's fluorescence on cell nuclei and masks around the cell nuclei. To be specific, FIG. 3A shows the state where the nucleus region of a cell is detected; FIG. 3B shows the state where the cytoplasm is defined by a region widened from the nucleus region; FIG. 3C shows the state where, under the condition where a bright cell and a dark cell are close together to overlap one another, the cytoplasm is defined by regions widened from the nucleus regions in the similar manner shown in FIG. 3B, and FIG. 3D shows the state where classification of cells is made using FIG. 3C condition.

FIG. 4 is a block diagram that shows the schematic configuration of the cell-image analyzing apparatus according to one mode for embodying the present invention.

FIG. 5 is a flow chart that shows the entire analysis procedure from capture of cell images through analysis of the cell images using the cell-image analyzing apparatus of this mode for embodiment.

FIGS. 6A-6D are explanatory diagrams that show one example of the method of determining cell kind using the cell-image analyzing apparatus according to Embodiment 2 of the present invention. To be specific, FIG. 6A shows an original cell image, FIG. 6B shows the state where cytoplasm region is delimited from the image of FIG. 6A, FIG. 6C shows the state where the center of the cytoplasm region of FIG. 6B is detected, and FIG. 6D shows the state where the center of the cytoplasm region of 6C is associated with the nucleus region of FIG. 6A.

FIGS. 7A-7E are explanatory diagrams show another example of the method of determining cell kind using the cell-image analyzing apparatus of Embodiment 2. To be specific, FIG. 7A shows an original cell image, FIG. 7B shows the state where cell nucleus regions are delimited from the image of FIG. 7A, FIG. 7C shows the state where the centers of cytoplasm regions in a fluorescence image of the channel 1 are detected from the image of FIG. 7A, FIG. 7D shows the state where the centers of cytoplasm regions in a fluorescence image of the channel 2 are detected from the image of FIG. 7A, and FIG. 7E shows the state where the centers of the cytoplasm regions in the fluorescence image of the channel 1 of FIG. 7C and the centers of the cytoplasm regions in the fluorescence image of the channel 2 of FIG. 70 are associated with the nucleus regions of FIG. 78.

FIGS. 8A-8F are explanatory diagrams that show the method of classifying cells using the cell-image analyzing apparatus according to Embodiment 3 of the present invention. To be specific, FIG. 8A shows the state where different kinds of cells overlap one another, FIG. 8B shows the state where cell nucleus regions are detected from the condition of FIG. 8A, FIG. 8C shows the state where a cytoplasm region in a fluorescence cell image of the channel 1 is detected from the state of FIG. 8A, FIG. 8D shows the state where a cytoplasm region in a fluorescence cell image of the channel 2 is detected from the state of FIG. 8A, FIG. 8E shows the overlap between one of the cell nucleus regions of FIG. 8A and the cytoplasm region in the fluorescence cell image of the channel 1, and FIG. 8F shows the overlap between the same one, as FIG. 8E, of the cell nucleus regions of FIG. 8A and the cytoplasm region in the fluorescence cell image of the channel 2.

FIGS. 9A and 9B are explanatory diagrams that show the method of classifying cells using the cell-image analyzing apparatus according to Embodiment 4 of the present invention. To be specific, FIG. 9A shows the entire region of cytoplasm, and FIG. 9B shows the state where the central region, which forms a soma, is defined from FIG. 9B.

FIGS. 10A-10C are explanatory diagrams that show the method of determining cytoplasm regions by the cell-image analyzing apparatus according to a reference example of Embodiment 5. To be specific, FIG. 10A shows a cell image in the state where two cells different in brightness overlap one another, FIG. 10B shows a cytoplasm region determined under the condition where the cell image of FIG. 10A is binarized with a threshold tuned for the dark cell, and FIG. 10C shows a cytoplasm region defined under the condition where the cell image of FIG. 10A is binarized with a threshold tuned for the bright cell.

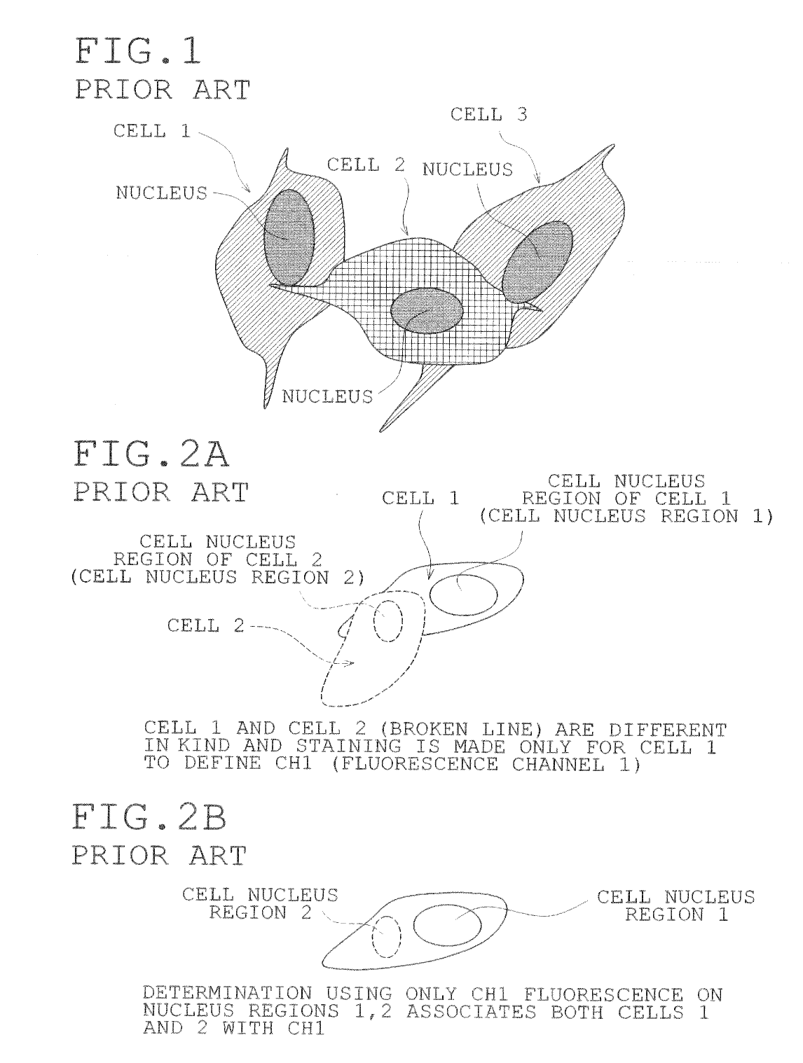

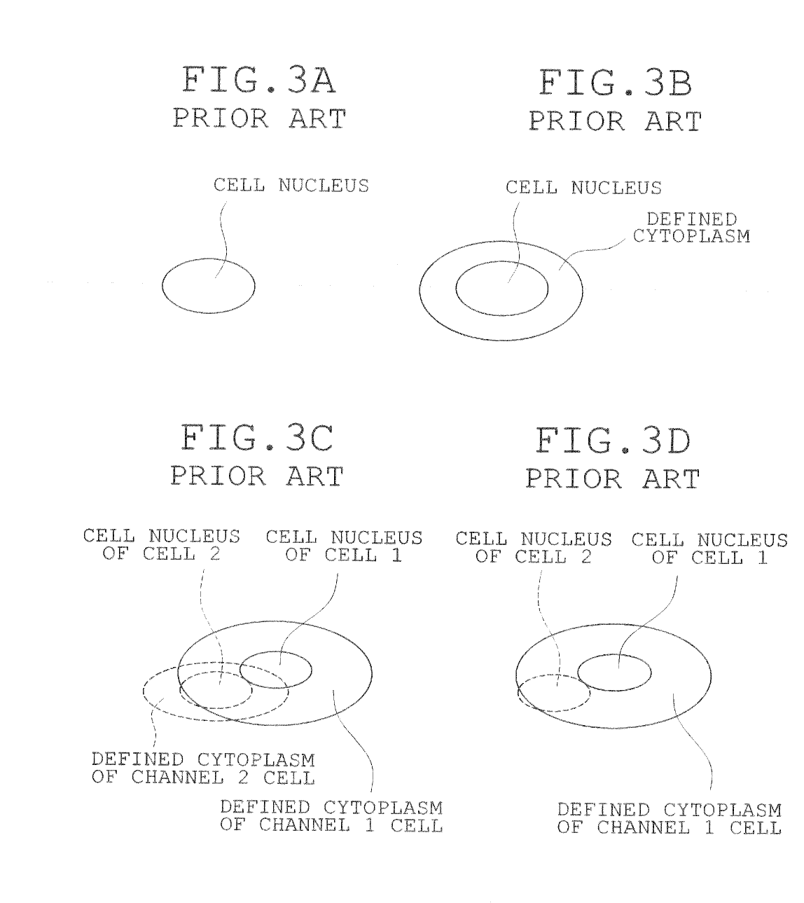

### DETAILED DESCRIPTION OF THE PREFERRED EMBODIMENTS

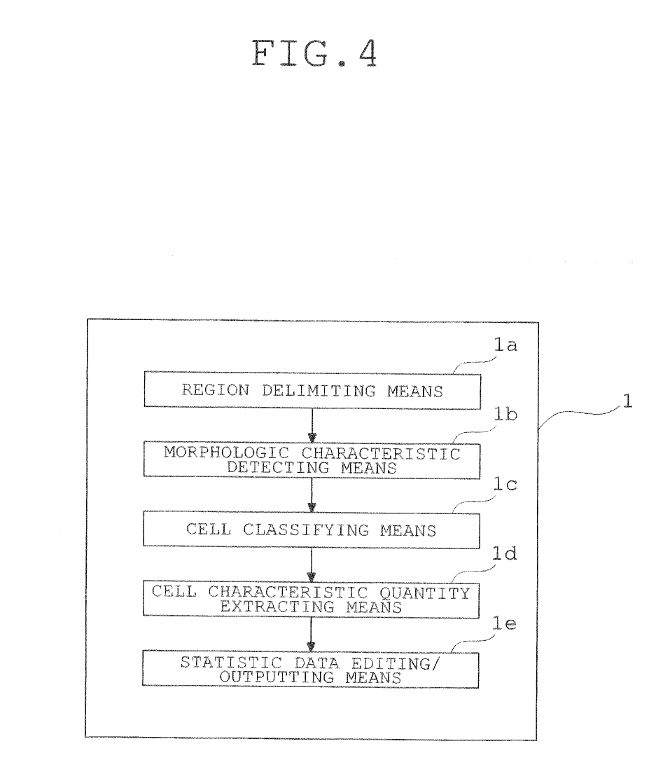

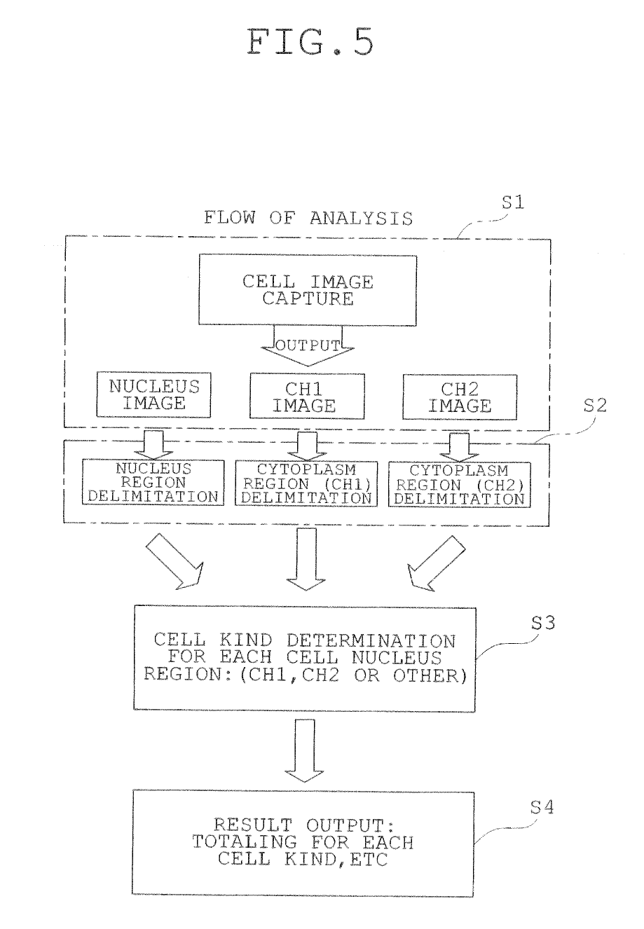

FIG. 4 is a block diagram that shows the schematic configuration of the cell-image analyzing apparatus according to one mode for embodying the present invention. FIG. 5 is a flow chart that shows the entire analysis procedure from capture of cell images through analysis of the cell images using the cell-image analyzing apparatus of this mode for embodiment.

A cell-image analyzing apparatus 1 of this mode for embodiment is provided with a computer and an image analysis software that makes the computer function as a region delimiting means 1a, a morphologic characteristic detecting means 1b, and a cell classifying means 1c. Further, the software makes the computer function as a cell characteristic quantity extracting means 1d and a statistic data editing/outputting means 1e, also.

The region delimiting means la delimits cell nucleus regions and cytoplasm regions in each of plural channels of fluorescence cell images on a specimen that contains plural kinds of cells and is stained with specific fluorochromes in accordance with the kinds of the cells.

The morphologic characteristic detecting means 1b detects characteristic of the cell nucleus regions and the cytoplasm regions delimited via the region delimiting means 1a.

The cell classifying means 1c classifies the cells into kinds in accordance with the morphologic characteristic on the cell nucleus regions or the cytoplasm regions detected via the morphologic characteristic detecting means 1b.

The cell characteristic quantity extracting means id extracts characteristic quantities such as brightness, morphology, etc. of each cell as classified.

The statistic data editing/outputting means 1e totals the number of cells in a captured image for each kind of cells , and further calculates, using the resulted sums, the grand total and/or a proportion in number of a specific group. In addition, it conducts statistic operations such as averaging or comparison of a cell characteristic quantity in each group or between groups, and outputs the operation results,

The cell analysis using the cell-image analyzing apparatus of this mode for embodiment thus configured is conducted in accordance with the procedure shown in FIG. 5.

In preparation of the cell analysis, staining of the cells is made using specific staining agents in accordance with cell kinds. In other words, the cells are stained with different staining agents in accordance with kinds of the cells. The cell nuclei also are stained with an appropriate compound such as DAPI (4′, 6-diamino-2-phenylindole)

Photographing shots for cell images are taken for each cell staining (for each channel) by a microscopic photographing apparatus not shown (Step S1). To be specific, at each of plural XY positions in the container located via a motorized stage not shown, plural images including an image of nucleus regions, a first (channel 1) fluorescence image, a second (channel 2) fluorescence image, etc are captured, The captured cell images are analyzed, with the cell-analyzing apparatus of this mode for embodiment.

First, the region delimiting means 1a delimits cell nucleus regions and cytoplasm regions in each of the plural channels of fluorescence cell images on the specimen that contains plural kinds of cells and is stained with the specific fluorochromes in accordance with the kinds of the cells (Step example of FIG. 5, cell nucleus regions, cytoplasm regions in the first (channel 1) fluorescence image, and cytoplasm regions in the second (channel 2) fluorescence image are delimited.

Next, the cell kind of each of the cell nucleus regions is determined (Step S3) In determination of the cell kind, first, the morphologic characteristic detecting means lb detects a morphologic characteristic on the cell nucleus regions or the cytoplasm regions delimited via the region delimiting means 1a. Then, the cell classifying means 1c classifies the cells into kinds in accordance with the morphologic characteristic on the cell nucleus regions or the cytoplasm regions detected via the morphologic characteristic detecting means 1b.

Next, the analysis result is output for each cell kind as classified. (Step 4) First, the cell characteristic quantity extracting means id extracts characteristic quantities such as brightness, morphology, etc. of each cell as classified, Then, the static data editing/outputting means 1e totals the number of cells in a captured image for each kind of cells, and further calculates, using the resulted sums, the grand total and/or a proportion in number of a specific group, In addition, it conducts statistic operations such as averaging or comparison of a cell characteristic quantity in each group or between groups, and outputs the operation results,

The cell-image analyzing apparatus of the present invention is characterized by the processings conducted by the region delimiting means 1a, the morphologic characteristic detecting means 1b, and the cell classifying means 1c. The processings will be explained more specifically in reference to the following embodiments.

### EMBODIMENT 1

(General Example: Example of Cell Classification into Kinds in Accordance with Morphologic Characteristic)

In the cell-image analyzing apparatus of Embodiment 1, the region delimiting means 1a conducts delimitation of cell nucleus regions, cytoplasm regions in the first (channel 1) fluorescence image, and cytoplasm regions in the second (channel 2) fluorescence image, at an XY coordinate position in concern of the container. Then, the morphologic characteristic detecting means 1b and the cell classifying means 1c determine kinds of the cells using these data delimited by the region delimiting means 1a.

### Delimitation of Cell Nucleus Regions

The region delimiting means la first conducts analysis of the cell nucleus image, to determine positions of cell nuclei and to delimit cell nucleus regions in the cell nucleus image. For example , it delimits the cell nucleus regions by simply setting a threshold for the cell nucleus image.

### Delimitation of Cytoplasm Regions

Regarding the first (channel 1) fluorescence image and the second (channel fluorescence image also, the region delimiting means 1a conducts analysis similar to the analysis of the cell nucleus image, to delimit cytoplasm regions in the respective fluorescence images.

### Determination of Cell Kind

Following the previous step, the morphologic characteristic detecting means lb first assigns, to the individual cell nucleus regions delimited via the region delimiting means 1a, numerals (identifiers) such as “1, 2, 3, . . . ” for identifying them. Then, the morphologic characteristic detecting means lb detects the morphologic characteristic by associating each of the cell nucleus regions with a cytoplasm region of the channel 1 or a cytoplasm region of the channel 2.

Then, the cell classifying means 1c determines kinds of the cells in accordance with the morphologic characteristics detected via the morphologic characteristic detecting means 1b.

### EMBODIMENT 2

(Example of Cell Classification into Kinds, Using Gravity Center (Center Point) as Morphologic Information)

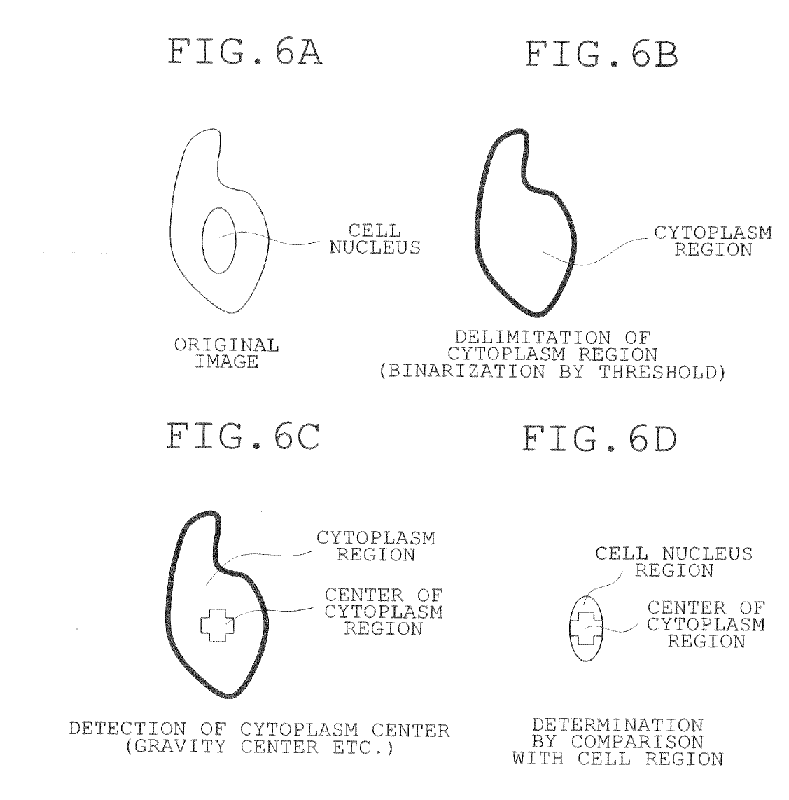

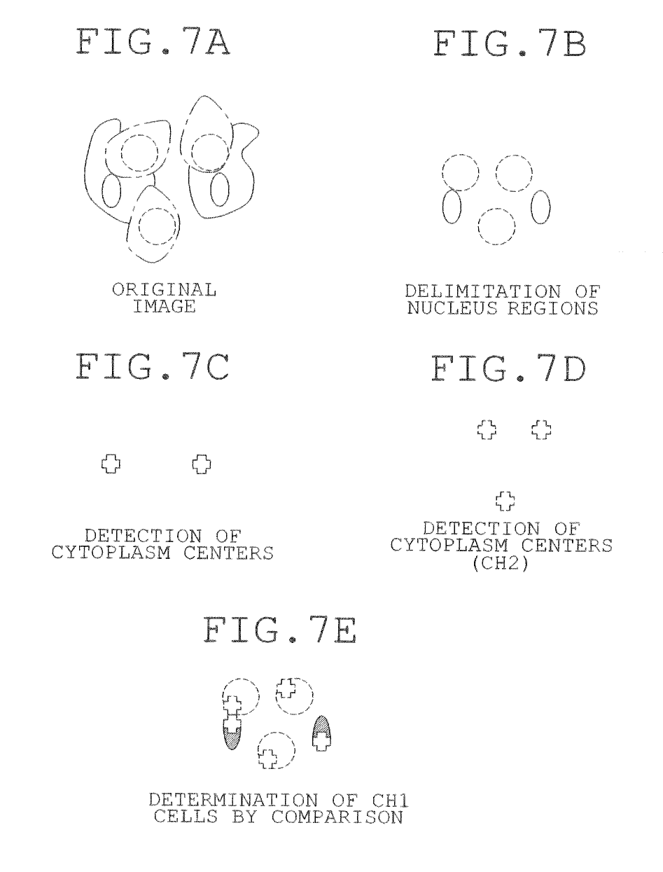

FIGS. 6A-6D are explanatory diagrams that show one example of the method of determining cell kind using the cell-image analyzing apparatus according to Embodiment 2 of the present invention. To be specific, FIG. 6A shows an original cell image, FIG. 6B shows the state where cytoplasm region is delimited from the image of FIG. 6A, FIG. 6C shows the state where the center of the cytoplasm region of FIG. 68 is detected, and FIG. 6D shows the state where the center of the cytoplasm region of 6c is associated with the nucleus region of FIG. 6A, FIGS. 7A-7E are explanatory diagrams that show another example of the method of determining cell kind using the cell-image analyzing apparatus of Embodiment 2. To be specific, FIG. 7A shows an original cell image, FIG. 7B shows the state where cell nucleus regions are delimited from the image of FIG. 7A, FIG. 7C shows the state where the centers of cytoplasm regions in a fluorescence image of the channel 1 are detected from the image of FIG. 7A, FIG. 7D shows the state where the centers of cytoplasm regions in a fluorescence image of the channel 2 are detected from the image of FIG. 7A, and FIG. 7E shows the state where the centers of the cytoplasm regions in the fluorescence image of the channel 1 of FIG. 7C and the centers of the cytoplasm regions in the fluorescence image of the channel 2 of FIG. 7D are associated with the nucleus regions of FIG. 7B.

The cell-image analyzing apparatus of Embodiment 2 classifies cells into kinds by using, as the morphologic information on each cytoplasm region of each channel, the gravity center (center point) of each cytoplasm region, as shown in FIGS. 6A-6D or FIGS. 7A-7E, for example.

To be specific, the region delimiting means 1a delimits, from the cell image shown in FIG. 6A, a cell nucleus region (not shown) and a cytoplasm region (FIG. 6B) in each of plural channels of fluorescence cell images on a specimen that contains plural kinds of cells and is stained with specific fluorochromes in accordance with the kinds of the cells.

The morphologic characteristic detecting means 1b detects the center point of the cytoplasm region delimited via the region delimiting means 1a, as shown in FIG. 6C, and detects the positional relation between the center point of the cytoplasm region and the cell nucleus region, as shown in FIG. 6D.

The cell classifying means 1c determines the kind of the cell in accordance with the positional relation between the center point of the cytoplasm region and the cell nucleus region detected via the morphologic characteristic detecting means 1b. When the center or the gravity center of a cytoplasm region in the fluorescence cell image of one channel is positioned on a particular cell nucleus region, this cell nucleus region is associated with this channel,

The similar processing may be made for plural channels as shown in FIGS. 7A-7E. Whereby, to each cell nucleus region, the channel of the fluorescence cell image that contains a cytoplasm region having the center point positioned on this cell region is assigned.

In the example of FIGS. 7A-7E, staining is made with two different fluorochromes, to produce cells stained for the channel 1 (shown by solid lines) and cells stained for the channel 2 (shown by broken lines).

The region delimiting means 1a delimits, from the cell image shown in FIG. 7A, cell nucleus regions (FIG. 7B) and cytoplasm regions (not shown) in each of the channel 1 and the channel 2 fluorescence cell images on the specimen that contains plural kinds of cells and is stained with the specific fluorochromes in accordance with the kinds of the cells.

The morphologic characteristic detecting means lb detects the center points of the cytoplasm regions in each of the channel 1 and the channel 2 fluorescence cell images delimited via the region delimiting means 1a, as shown in FIGS. 7C-7D, and detects positional relations each between one of the center points of the cytoplasm regions and one of the cell nucleus regions, as shown in FIG. 7E.

The cell classifying means is determines the kinds of the cells in accordance with the positional relations each between one of the center points of the cytoplasm regions and one of the cell nucleus regions detected via the morphologic characteristic detecting means 1b. In the example of FIG. 7E, cell nucleus regions belonging to the channel 1 cells are determined.

The other configurations and functions of Embodiment 2 are substantially the same as the cell-image analyzing apparatus of Embodiment 1.

### Modification Example of Embodiment 2

While the cell-image analyzing apparatus of Embodiment 2 is configured to conduct classification of cells into kinds using the center points (gravity center) of cytoplasm regions, the explanation is made of a modification example configured to conduct classification of cells into kind in a manner similar to the cell-image analyzing apparatus of Embodiment 2.

The cell-image analyzing apparatus of Embodiment 2 is configured on the basis of the premise that only one center point, out of the respective center points of the cytoplasm regions in the fluorescence cell images of the channels 1 and 2, exists on one cell nucleus region.

However, in some cell images where cells are clustered, center points of cytoplasm regions in fluorescence cell images of different channels may possibly appear on one cell nucleus region.

The cell-image analyzing apparatus of this modification example is configured in consideration of such a case.

The cell-image analyzing apparatus of this modification example is configured so that the morphologic characteristic detecting means 1b associates cell nucleus regions with channels in the following manner

That is the morphologic characteristic detecting means 1b detects the respective center points of the cell nucleus regions, the cytoplasm regions in the fluorescence cell image of the channel 1, and the cytoplasm regions in the fluorescence cell image of the channel 2, and then defines, among the center points of the cytoplasm regions in the fluorescence cell, image of the channel 1 and the center points of the cytoplasm regions in the fluorescence cell image of the channel 2, the point that is closest to the center point of a cell nucleus region in concern, as a center point, of the cytoplasm region that should be associated with the cell nucleus region in concern.

After this operation, the morphologic characteristic detecting means 1b detects the positional relation between the center of the cytoplasm region as defined and the cell nucleus in concern, as in the cell-image analyzing apparatus of Embodiment 2. The cell classifying means 1c also behave the same as in the cell-image analyzing apparatus of Embodiment 2, to determine the kind of the cell in accordance with the positional relation between the center point of the cytoplasm region and the cell nucleus region detected via the morphologic characteristic detecting means 1b.

According to the cell-image analyzing apparatus of the modification example, among the center points of the cytoplasm regions, the point closest to the center point of the cell nucleus region in concern is taken as a point to represent the cytoplasm region to be associated with the cell nucleus region in concern, to form the morphologic information, Therefore, even if cells are clustered and center points of cytoplasm regions in fluorescence cell images of different channels appear on one cell nucleus region, it is possible to assign a single channel to each cell.

### EMBODIMENT 3

(Example of Cell Classification into Kinds, Using Overlaps Between One Cell Nucleus Region and Cytoplasm Regions of Respective Channels)

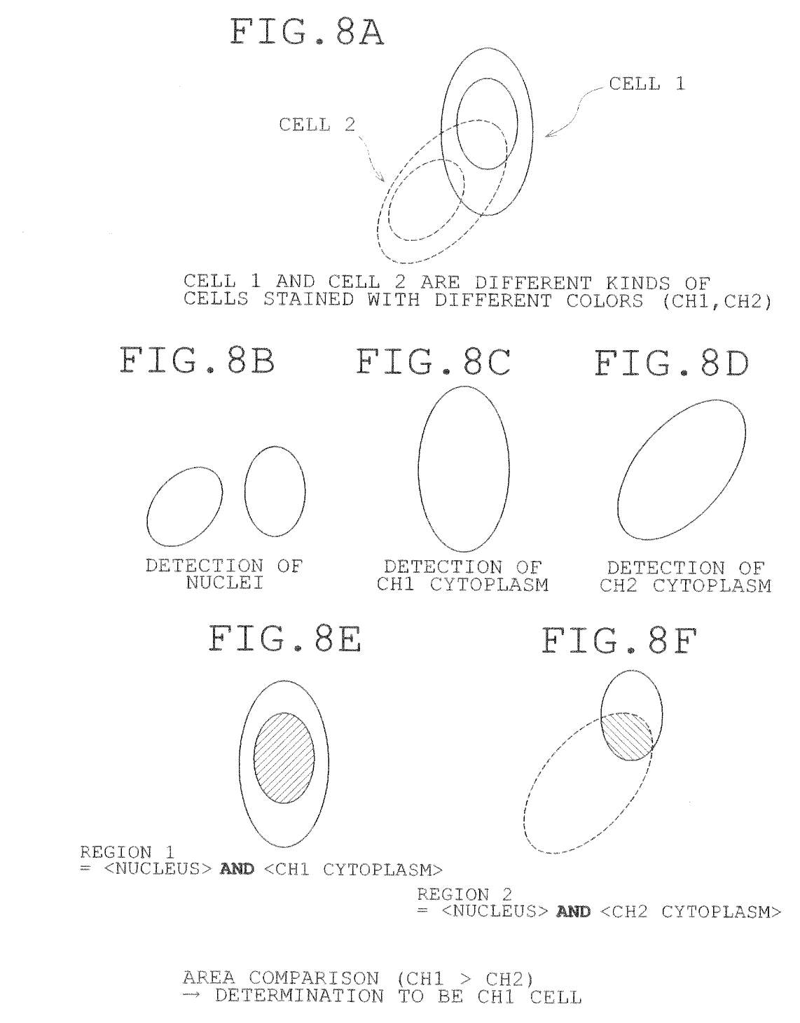

FIGS. 8A-8F are explanatory diagrams that show the method of classifying cells using the cell-image analyzing apparatus according to Embodiment 3 of the present invention. To be specific, FIG. 8A shows the state where different kinds of cells overlap one another, FIG. 8B shows the state where cell nucleus regions are detected from the condition of FIG. 8A, FIG. 8C shows the state where a cytoplasm region in a fluorescence cell image of the channel 1 is detected from the state of FIG. 8A, FIG. 8D shows the state where a cytoplasm region in a fluorescence cell image of the channel 2 is detected from the state of FIG. 8A, FIG. 8E shows the overlap between one of the cell nucleus regions of FIG. 8A and the cytoplasm region in the fluorescence cell image of the channel 1, and FIG. 8F shows the overlap between the same one, as FIG. 8E, of the cell nucleus regions of FIG. 8A and the cytoplasm region in the fluorescence cell image of the channel 2.

The cell-image analyzing apparatus of Embodiment 3 is the same as the cell-image analyzing apparatus of Embodiment 1 in basic configuration, and is configured to use, as morphologic information other than that of Embodiment 2, the overlaps each between one cell nucleus region and cytoplasm regions of respective channels, for determining the cell kind.

That is, in the cell-image analyzing apparatus of Embodiment 3, the morphologic characteristic detecting means 1b detects overlaps each between one of the cytoplasm regions and one of the cell nucleus regions delimited via, the region delimiting means 1a.

In addition, the cell classifying means 1c automatically classifies the cells into specific cell kinds, respectively, in accordance with a relation in size between the respective overlaps each between one of the cytoplasm regions and one of the cell nucleus regions.

The explanation will made of the procedure of classifying the cell 1 and the cell 2 from the cell image of FIG. 8A in the state where the cell 1 and the cell 2 overlap one another.

In the cell-image analyzing apparatus of Embodiment 3 also, the processings until cytoplasm regions in each channel of the fluorescence cell image are delimited are substantially the same as the cell-image analyzing apparatus of Embodiment 1. That is, the region delimiting means 1a delimits cell nucleus regions (FIG. 8B) , and delimits cytoplasm regions in the fluorescence cell image of the channel 1 (FIG. 8C) and cytoplasm regions in the fluorescence cell image of the channel 2 (FIG. 8D).

Then, the morphologic characteristic detecting means 1b delimits “overlaps” each between a common cell nucleus region and a cytoplasm region in the fluorescence cell image of each channel by “AND” operation (FIG. 8E, FIG. 8F).

Then, the cell classifying means 1c compares the areas of the overlaps, determines which channel's overlap has a larger area, and associates this channel to the cell nucleus. In the example of FIGS. 8A-8F, since the overlap (overlap 1, shown in FIG. 8E) between the common cell nucleus region and the cytoplasm region in the fluorescence image of the channel 1 has a larger area than the overlap (overlap 2, shown in FIG. 8F) between the common cell nucleus region and the cytoplasm region in the fluorescence image of the channel 2, the common cell nucleus is associated with the channel 2.

By conducting the same processing for the other cell nucleus regions also, each individual of the the cell nucleus regions and the cytoplasm regions is assigned to either channel. Whereby, the cells are classified into cell kinds.

### EMBODIMENT 4

(Example of Cell Classification into Kinds, Using Somas (Central Regions of Cytoplasm))

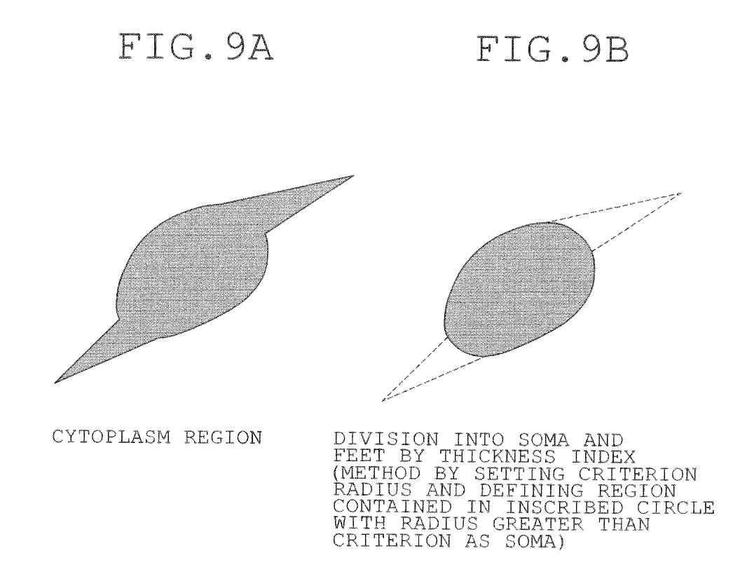

FIGS. 9A and 9B are explanatory diagrams that show the method of classifying cells using the cell-image analyzing apparatus according to Embodiment 4 of the present invention. To be specific, FIG. 9A shows the entire region of cytoplasm, and FIG. 8B shows the state where the central region, which forms a soma, is defined from FIG. 9B.

The cell-image analyzing apparatus of Embodiment 4 is configured to define regions about the centers of cytoplasm by excluding projections of the cells, as the pre-stage operation for classifying cells using overlaps between cell nucleus regions and cytoplasm regions as in the cell-image analyzing apparatus of Embodiment 3.

In the cell-image analyzing apparatus of Embodiment 4, the morphologic characteristic detecting means 1b detects central regions, which form somas, from the cytoplasm regions delimited via the region delimiting means 1a, and quantifies states regarding overlaps between the central regions forming the somas and the cell nucleus regions. The cell classifying means 1c automatically classifies the cells into specific cell, kinds, respectively, in accordance with the states regarding the overlaps between the central regions forming the somas and the cell nucleus regions as in Embodiment 3, for example, 5. In the example of FIGS. 9A-9B, the morphologic characteristic detecting means 1b detects, regarding the cytoplasm region shown in FIG. 9A, the central region as a soma upon excluding the marginal portions having the shape of projections, For example, with a parameter of “thickness” being preliminarily set, in terms of the criterion radius, a circle having a radius greater than the criterion radius is placed on the cytoplasm region, and the region contained in this inscribed circle is defined as a soma. while thin projections not contained in the inscribed circle is excluded.

According to the cell-image analyzing apparatus of Embodiment 4, since the cytoplasm region is more narrowly defined nearer the center of the cell, the accuracy of cell kind determination is improved.

### EMBODIMENT 5

### (Example of Delimitation of Cytoplasm Region Using Cell Nucleus Region)

The cell-image analyzing apparatus of Embodiment 5 is configured to use, in delimitation of cytoplasm regions, the previously determined information on cell nucleus regions.

To be specific, the region delimiting means la delimits cell nucleus regions in the fluorescence cell image of each channel, analyzes fluorescence distribution in neighbouring regions around the cell nucleus regions for detecting luminance of cytoplasm in the neighbouring regions, and determines cytoplasm regions near central portions of somas in accordance with the luminance of the cytoplasm in the neighbouring regions around the cell nucleus regions.

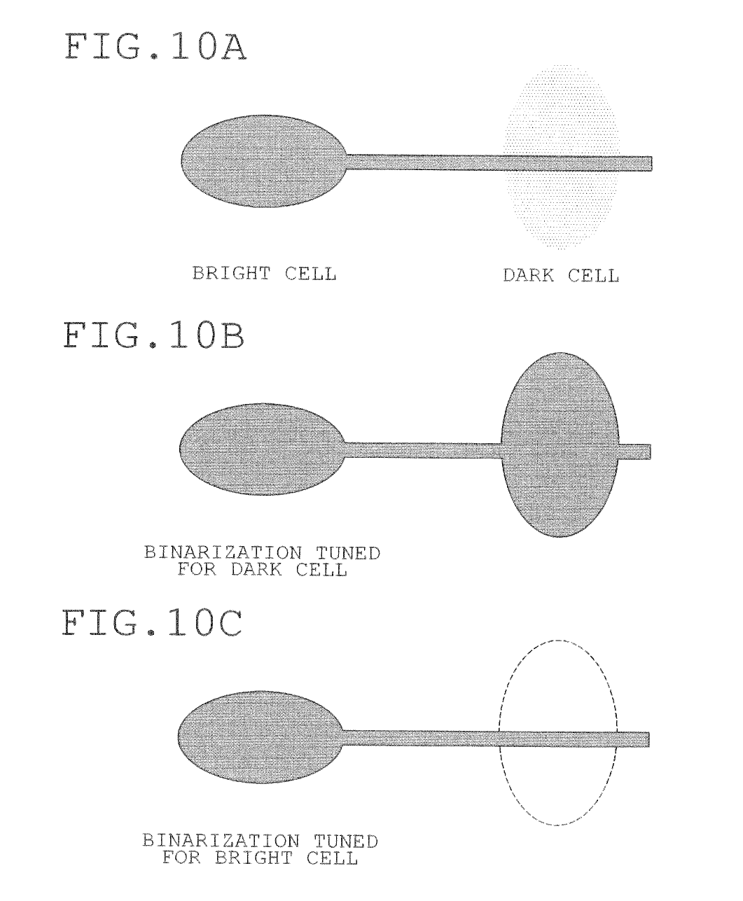

FIGS. 10A-10C, are explanatory diagrams that show the method of determining cytoplasm regions by the cell image analyzing apparatus according to a reference example of Embodiment 5. To be specific, FIG. 10A shows a cell image in the state where two cells different in brightness overlap one another, FIG. 10B shows a cytoplasm region determined under the condition where the cell image of FIG. 10A is binarized with a threshold tuned for the dark cell, and FIG. 10C shows a cytoplasm region defined under the condition where the cell image of FIG. 10A is binarized with a threshold tuned for the bright cell.

FIG. 10A shows the example of an overlap of two cells. One of the cells (cell 1) is bright with its foot overlapping the region of the other cell (cell 2) The cell 2 is very dark in comparison with the cell 1.

The difference in brightness of these cells is due to some trouble in staining or so, which is a very common trouble.

In this case, if the image is binarized to be tuned for the bright cell 1 (in setting of the threshold), the two cells are defined as dominated by a single region of cytoplasm, as shown in FIG. 10C. In short, the dark cell is regarded as absent.

In contrast, if the image is biniarized to be tuned for the dark cell (in setting of the threshold), the dark cell also is detectable as shown in FIG. 10B. However, this manner of binarization does not, make it possible to analyze a sample image with a high cell density, for the detected region as exceeding the threshold of binarization is wider than the original region which should have been detected and thus makes it difficult to distinguish boundaries between cells.

Therefore, in the cell-image analyzing apparatus of Embodiment 5, the region delimiting means 1a first delimits cell nucleus regions.

The region delimiting means 1a then calculates the optimum cytoplasm luminance in reference to the cell nucleus regions in the fluorescence image of each channel. For example, in accordance with a distribution of cytoplasm fluorescence in the cell nucleus regions and the neighbouring regions around them, the median of the distribution is taken as a most typical value of the cytoplasm fluorescence there. This most, typical value is detected as the luminance of the cytoplasm regions around the cell nucleus regions in each channel.

Then, in accordance with the luminance of cytoplasm in the neighbouring regions around the cell nucleus regions, cytoplasm regions near the central portions of somas are determined.

In this way, cytoplasm regions of dark cells and cytoplasm regions of bright sells are determined, respectively.

Regarding the morphologic characteristic detecting means 1b and the cell classifying means 1c, those having the same configurations as the morphologic: characteristic detecting means 1b and the cell classifying means 1c in the cell-image analyzing apparatus of any of Embodiments 1-4 are applied.

Use of the region delimiting means of the cell-image analyzing apparatus of Embodiment 5 also facilitates appropriate classification of cells, as in the cell-image analyzing apparatuses of Embodiments 1-4.

The cell-image analyzing apparatus of the present invention is useful in the field of automatic analysis of cell images, to be specific, the field of automatic analysis of neural cells.

What is claimed is:

1. A cell-image analyzing apparatus provided with a computer, for classifying cells using plural channels of fluorescence cell images on a specimen that contains plural kinds of cells and is stained with specific fluorochromes in accordance with the kinds of cells;
wherein the cell-image analyzing apparatus comprises an image analysis software that makes the computer function as:
a region delimiting means for delimiting cell nucleus regions and cytoplasm regions in each of the plural channels of fluorescence cell images;
a morphologic characteristic detecting means for detecting a morphologic characteristic on the cell nucleus regions or the cytoplasm regions delimited via the region delimiting means; and
a cell classifying means for classifying the cells into cell kinds in accordance with the morphologic characteristic on the cell nucleus regions or the cytoplasm regions detected via the morphologic characteristic detecting means.

2. A cell-image analyzing apparatus according to claim 1,
wherein the morphologic characteristic detecting means detects positions of center points of the cytoplasm regions delimited via the region delimiting means and detects positional relations between the center points of the cytoplasm regions and the cell nucleus regions, and
wherein the cell classifying means automatically classifies the cells into specific cell kinds, respectively, in accordance with the positional relations between the center points of the cytoplasm regions and the cell nucleus regions detected via the morphologic characteristic detecting means.

3. A cell-image analyzing apparatus according to claim 1,
wherein the morphologic characteristic detecting means detects central regions, which form somas, from the cytoplasm regions delimited via the region delimiting means and quantifies states regarding overlaps between the central regions forming the somas and the cell nucleus regions, and
wherein the cell classifying means automatically classifies the cells into specific cell kinds, respectively, in accordance with the states regarding the overlaps between the central regions forming the somas and the cell nucleus regions.

4. A cell-image analyzing apparatus according to claim 1,
wherein the morphologic characteristic detecting means detects overlaps each between one of the cytoplasm regions and one of the cell nucleus regions delimited via the region delimiting means, and
wherein the cell classifying means automatically classifies the cells into specific cell kinds, respectively, in accordance with a relation in size between the respective overlaps each between one of the cytoplasm regions and one of the cell nucleus regions.

5. A cell-image analyzing apparatus according to claim 1,
wherein the region delimiting means delimits the cell nucleus regions in each of the plural, channels of fluorescence cell images, analyzes fluorescence distribution in neighbouring regions around the cell nucleus regions for detecting luminance of cytoplasm in the neighbouring regions, and determines the cytoplasm regions near central portions of somas in accordance with the luminance of the cytoplasm in the neighbouring regions around the cell nucleus regions.
